(19) United States
(12) Patent Application Publication
(10) Pub. No.: US 2008/0107101 A1
(43) Pub. Date: May 8, 2008

(54) Multi-dialing-number VOIP phone call connection method

(75) Inventor: Tso-Ping Liu, Changhua County (TW)

Correspondence Address: BIRCH STEWART KOLASCH & BIRCH, PO BOX 747, FALLS CHURCH, VA, 22040-0747, US

(73) Assignee: Mitac Technology Corp.

(21) Appl. No.: 11/591,639

(22) Filed: Nov. 2, 2006

(51) Int. Cl. H04L 12/66

(52) U.S. Cl. 370/352

(57) ABSTRACT

A multi-dialing-number VOIP phone call connection method, comprising the following steps: Firstly, registering by a first calling party with at least two proxy servers utilizing a network address, thus obtaining at least two dialing numbers; issuing by the calling party a calling invitation to the proxy server by making use of one of the dialing numbers; inquiring the address information of the second calling party by the proxy server according to the calling invitation; transmitting the calling invitation to the second calling party from the proxy server according to the address information; returning a confirmation message to the proxy server by the second calling party; transmitting and relaying such a confirmation message to the first calling party by the proxy server, thus realizing the phone call connection between the two parties; and establishing a real-time communication channel for transmitting data flow.

### BACKGROUND

1. Field of Invention

The invention relates to a Voice Over Internet Protocol (VOIP) phone call connection method, and in particular to a multi-dialing-number VOIP phone call connection method.

2. Related Art

Voice Over Internet Protocol (VOIP) is a kind of communication technology used to transmit voice packets through Internet in a digitalized manner. In general, the communication utilizing VOIP can be classified into the following three categories depending on the types of terminal devices utilized: (1) personal computer-to-personal computer (PC-to-PC), in this manner, a calling party may carry on phone conversation with a called party through a server, by simply logging onto a server of the service provider through a pertinent software by means of a PC; (2) personal computer-to-telephone (PC-to-Phone), in this case, upon logging onto the server of the service provider through a software, a calling party may proceed with the dialing and making of ordinary local phone call or mobile phone call by making use of a software provided by the telephone operating company; (3) telephone-to-telephone (phone-to-phone), in this case, all the user has to do is to add additionally a Terminal Adapter (TA) or VOIP Gateway, then he/she can be connected to a network, thus establishing phone communication with an opposite party by means of an existing household telephone set as a terminal device.

Usually, the user of VOIP may register with only a server at a time. The server is in charge of the managing the dialing numbers of VOIP, and that are used to certify the identity and authority of the user through verifying his/her account code, password, and network address (IP address). In other words, usually, a network address corresponds to a network phone number. As such, the multi-dialing-number telephone connection service is out of the question.

Therefore, the research and development of multi-dialing-number VOIP phone call connection method, hereby achieving an increase of dialing numbers available to use for the respective users is an important and urgent task in this field.

### SUMMARY OF THE INVENTION

In view of the above-mentioned drawbacks and shortcomings of the prior art, the objective of the invention is to provide a multi-dialing-number VOIP phone call connection method, that can be used to increase the dialing numbers of VOIP through multi-registrations of the respective users, thus raising the convenience of making VOIP phone calls through enhanced management.

Therefore, to achieve the above-mentioned purpose, the invention provides a multi-dialing-number VOIP phone call connection method, including the following steps. Firstly, the first calling party registers with at least two proxy servers utilizing one of its network addresses to obtain at least two related dialing numbers. Next, the first calling party sends out a calling invitation to a proxy server by utilizing one of the two dialing numbers thus obtained. Then, a proxy server inquires and searches the address information of the second calling party based on the calling invitation, namely, the proxy server searches and obtains from an address server the address information of the second calling party. Then, the proxy server transmits the calling invitation to the second calling party notifying it of the incoming call according to the address information. Subsequently, the second calling party returns an acknowledgement message to the proxy server. And finally, the proxy server relays and transmits such an acknowledgement message to the first calling party, thus realizing the phone call connection between the two parties. As such, establishing a real-time communication channel for transmitting data flow.

In addition, to achieve the above-mentioned purpose, the invention provides another multi-dialing-number VOIP phone call connection method, including the following steps. Firstly, the first calling party registers with a proxy server utilizing at least two network addresses to obtain at least two related dialing numbers. Next, the first calling party sends out a calling invitation to the proxy server by utilizing one of the two dialing numbers. Then, the proxy server inquires and searches the address information of the second calling party based on the calling invitation; namely, the proxy server searches and obtains from an address server the address information of the second calling party. Subsequently, the proxy server transmits the calling invitation to the second calling party notifying it of the incoming call according to the address information. Then, the second calling party returns an acknowledgement message to the proxy server. And finally, the proxy server relays and transmits such an acknowledgement message to the first calling party, thus realizing the phone call connection between the two parties. As such, establishing a real-time communication channel for transmitting data flow.

Moreover, to achieve the above-mentioned purpose, the invention provides still another multi-dialing-number VOIP phone call connection method, including the following steps. Firstly, the first calling party registers with a proxy server using two network addresses to obtain at least two related dialing numbers. Next, the first calling party takes actions in setting all or a part of the operation conditions for the dialing numbers (such as, communication allowable time sections or specific dialing numbers allowed) and transmits them to the proxy server for storage. Then, the second calling party sends out a calling invitation corresponding to the dialing number to the proxy server. Subsequently, the proxy server determines if the calling invitation issued by the second calling party is compatible with the operation conditions. Then, upon determining that the calling invitation is compatible with the operation conditions, the proxy server searches and obtains the address information of the first calling party based on the calling invitation. Furthermore, the proxy server sends out a calling invitation to the first calling party according to the address information thus obtained. Then, upon receiving such a calling invitation, the first calling party returns an acknowledgement message to proxy server. And finally, the proxy server relays and transmits such a acknowledgement message back to the second calling party, thus realizing the phone call connection between the two parties. As such, establishing a real-time communication channel for transmitting data flow.

Therefore, through the application of such a multi-dialing-number VOIP phone call connection method, the quantity of phone dialing numbers available for VOIP can be increased through registering the calling party with different proxy servers utilizing one network address to obtain a plurality of dialing numbers, or through registering the calling party with the same proxy server utilizing several network addresses to obtain a plurality of dialing numbers, thus increasing the phone dialing numbers available for the VOIP users. As such, the user may utilize the dialing numbers thus obtained to realize the phone call connection, hereby raising the convenience of utilizing VOIP through switching the phone connection call between the inside extension lines and the outside lines in a hardware or software manner.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow for illustration only, and thus are not limitative of the invention, and wherein:

FIG. 1 is a flowchart of a multi-dialing-number VOIP phone call connection method according to a first embodiment of the invention;

FIG. 2 is a flowchart of a multi-dialing-number VOIP phone call connection method according to a second embodiment of the invention;

FIG. 3 is a flowchart of a multi-dialing-number VOIP phone call connection method according to a third embodiment of the invention; and

FIG. 4 is a schematic diagram of a multi-dialing-number VOIP phone call connection system according to an embodiment of the invention.

### DETAILED DESCRIPTION OF THE INVENTION

The purpose, construction, features, and functions of the invention can be appreciated and understood more thoroughly through the following detailed description with reference to the attached drawings.

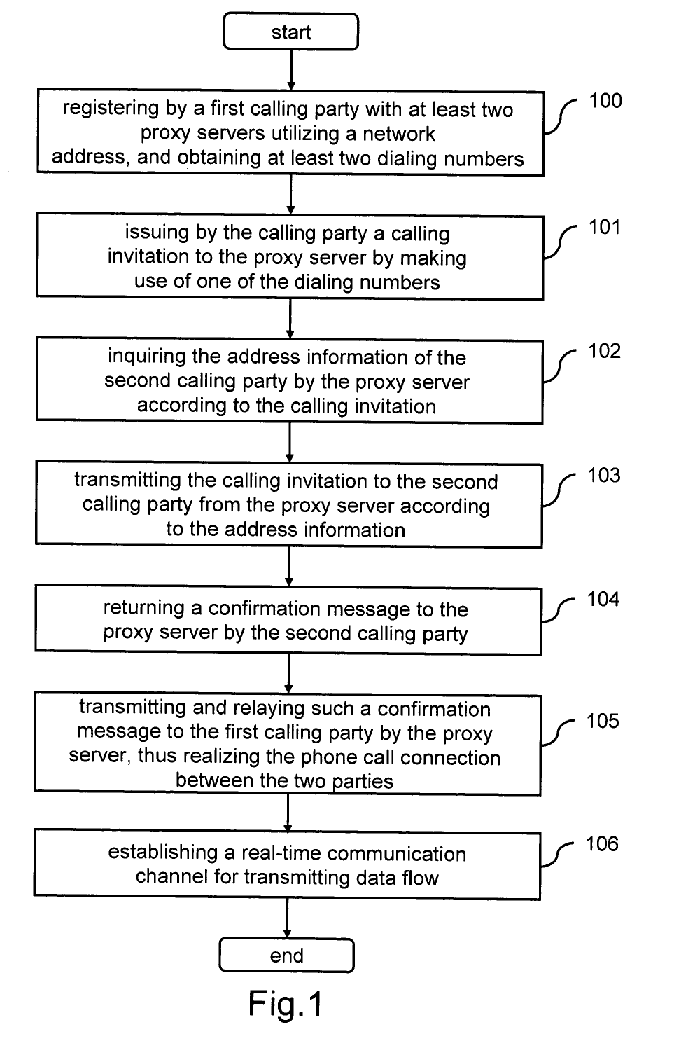

Firstly, refer to FIG. 1 for the steps of a multi-dialing-number VOIP phone call connection method according to a first embodiment of the invention. As shown in FIG. 1, the multi-dialing-number VOIP phone call connection method of the invention includes the following steps.

To begin with, the first calling party register with at least two proxy servers utilizing its network address, thus obtaining at least two dialing numbers (step 100). As such, through registering with various proxy servers, more than one dialing number can be obtained. In the present embodiment, the Session Initiation Protocol (SIP) is taken as an example for explanation. In case that H.323 protocol is utilized, then the first calling party registers its network address with a Gate keeper; or in case that a Media Gateway Control Protocol (MGCP) is utilized, then the first calling party registers its network address with a Call Agent.

Next, the first calling party proceeds with the communication operation according to one of the dialing numbers obtained in the registration, and transmits a calling invitation to the proxy server (step 101). In this connection, the invitation message includes the functions of: invitation, acknowledgement, option selection, bye, cancellation, and registration. Then, upon receiving the calling invitation, the proxy server inquires and obtains the address information of the second calling party according to the calling invitation (step 102). In this step, the proxy server is used to inquire an address server for the address information of the second calling party. Subsequently, the proxy server sends out a calling invitation to the second calling party according to the address information thus obtained (step 103).

Then, upon receiving the calling invitation, the second calling party verifies that it is in a communication allowable state, and returns a confirmation message to the proxy server (step 104). And finally, on receiving the confirmation message returned by the second calling party, the proxy server transmits such a confirmation message to the first calling party (step 105), thus realizing the phone call connection between the two parties. As such, establishing a real-time communication channel for transmitting data flow (for example, the voice packets)(step 106).

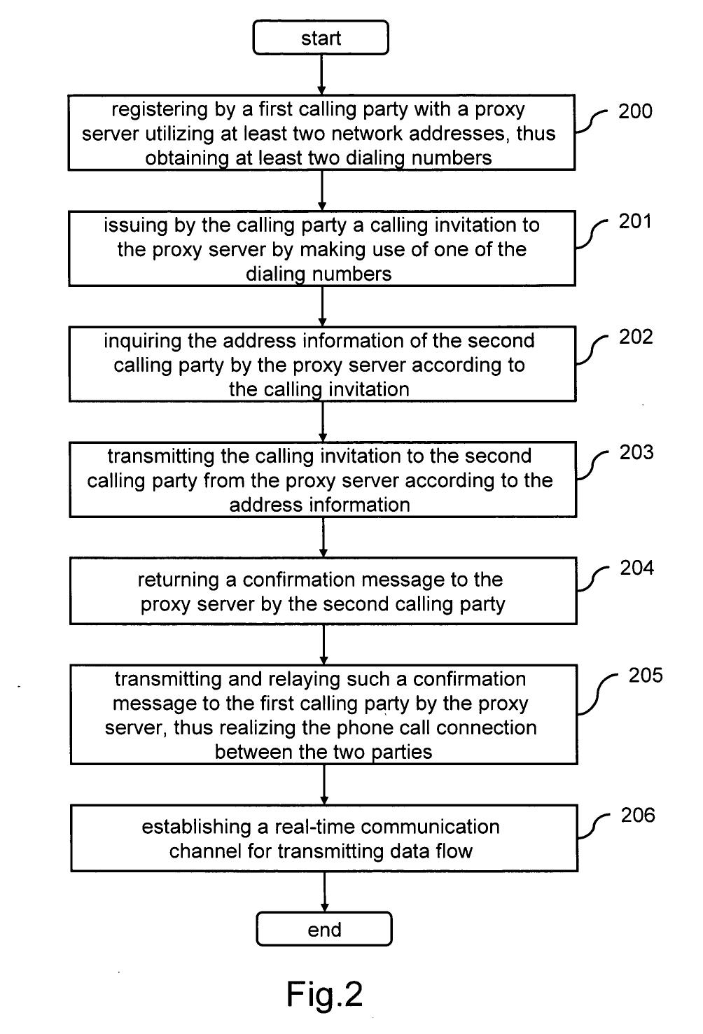

Moreover, refer to FIG. 2 for the steps of a multi-dialing-number VOIP phone call connection method according to a second embodiment of the invention. As shown in FIG. 2, the multi-dialing-number VOIP phone call connection method of the invention includes the following steps.

Firstly, the first calling party register with a proxy server utilizing two network addresses (IP), thus obtaining at least two dialing numbers (step 200). As such, in this embodiment, different network addresses are utilized to registered with the same proxy server, hereby obtaining a plurality of dialing numbers. In this respect, in practice, the network address of the first calling party can be obtained in a form of software simulated network address, or through the addition of a hardware network interface, thus realizing more than one network addresses.

Next, the first calling party proceeds with the communication operation according to one of the dialing numbers obtained in the registration, and transmits a calling invitation to the proxy server (step 201). In this connection, the invitation message includes the functions of: invitation, acknowledgement, option selection, bye, cancellation, and registration. Then, upon receiving the calling invitation, the proxy server inquires and obtains the address information of the second calling party according to the calling invitation (step 202). In this step, the proxy server is used to inquire an address server for the address information of the second calling party. Subsequently, the proxy server sends out a calling invitation to the second calling party according to the address information thus obtained (step 203).

Then, upon receiving the calling invitation, the second calling party verifies that it is in a communication allowable state, and returns a confirmation message to the proxy server (step 204). And finally, on receiving the confirmation message sent from the second calling party, the proxy server transmits such a confirmation message to the first calling party (step 205), thus realizing the phone call connection between the two parties. As such, establishing a real-time communication channel for transmitting data flow (for example, the voice packets)(step 206).

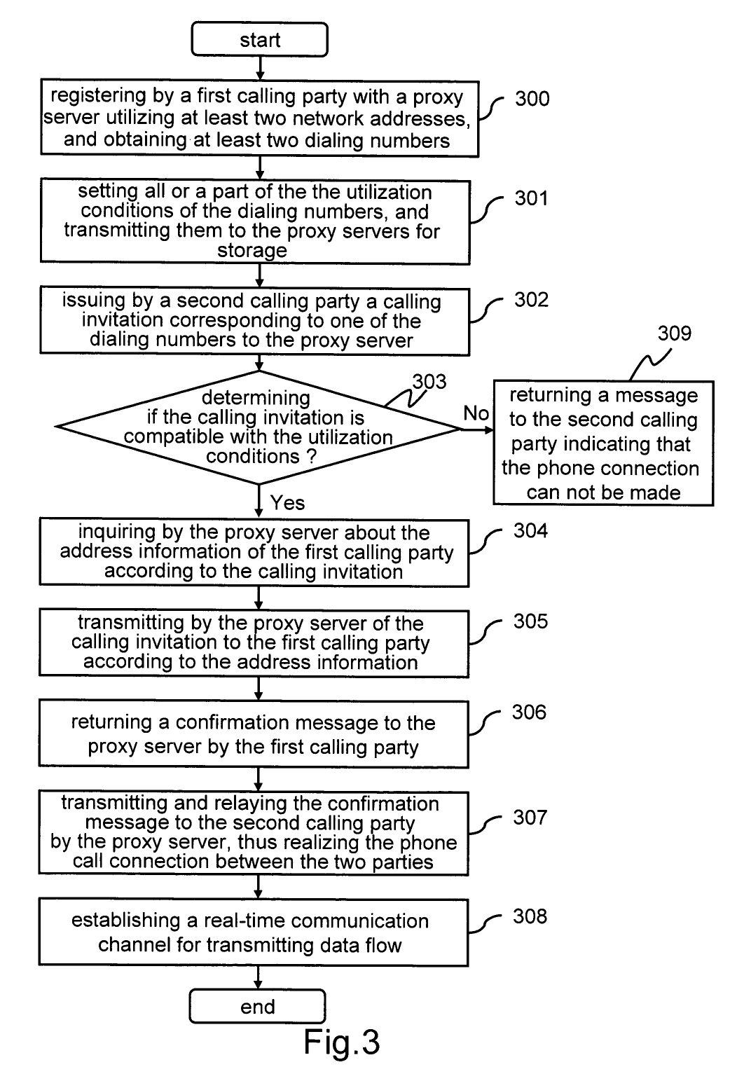

Moreover, refer to FIG. 3 for the steps of a multi-dialing-number VOIP phone call connection method according to a third embodiment of the invention. As shown in FIG. 3, the multi-dialing-number VOIP phone call connection method of the invention includes the following steps.

Firstly, the first calling party register with a proxy servers utilizing two network addresses, thus obtaining at least two dialing numbers (step 300). As such, through registering with the same proxy server utilizing different network addresses, a plurality of dialing numbers can be obtained. In the present embodiment, the network address of the first calling party can be obtained in a form of software simulated network address, or through the addition of a hardware network interface, thus realizing more than one network addresses.

Next, the first calling party takes actions in setting all or a part of the operation conditions for the dialing numbers, and then transmits them to the proxy server for storage (step 301). In this connection, the utilization conditions include: communication allowable time sections or specific dialing numbers allowed, such that the undesirable incoming calls can be filtered out according to the user's preferences. In practice, such utilization conditions are used to compare the time of the incoming calls with the communication allowable time sections, or the dialing number of the incoming call with the specific dialing numbers allowed, hereby determining if the incoming call is compatible with the utilization conditions. Then, a second calling party sends out a calling invitation corresponding to one of registered dialing numbers of the first calling party to the proxy server (step 302). In this respect, the invitation message includes the functions of: invitation, acknowledgement, option selection, bye, cancellation, and registration.

Subsequently, upon receiving the calling invitation sent by the second calling party, the proxy server determines if it is compatible with the utilization conditions (step 303). In case that the calling invitation is not compatible with the utilization condition (for example, it is not in the communication allowable time section set by the first calling party), then it returns the “connection not allowed” message to the second calling party (step 309); and in case that the calling invitation sent by the second calling party is compatible with the utilization condition, then the proxy server inquires about the address information of the first calling party according to the calling invitation(step 304). In this regard, the proxy server inquires an address server for the address information of the first calling party.

Then, the proxy server sends out the calling information to the first calling party according to the address information thus obtained (step 305). Subsequently, upon receiving the calling invitation, the first calling party verifies that the calling invitation is in the communication allowable state, and returns a confirmation message to the proxy server (step 306). And finally, on receiving the confirmation message sent from the first calling party, the proxy server transmits such a confirmation message to the second calling party (step 307), thus realizing the phone call connection between the two parties. As such, establishing a real-time communication channel for transmitting data flow (for example, the voice packets)(step 308).

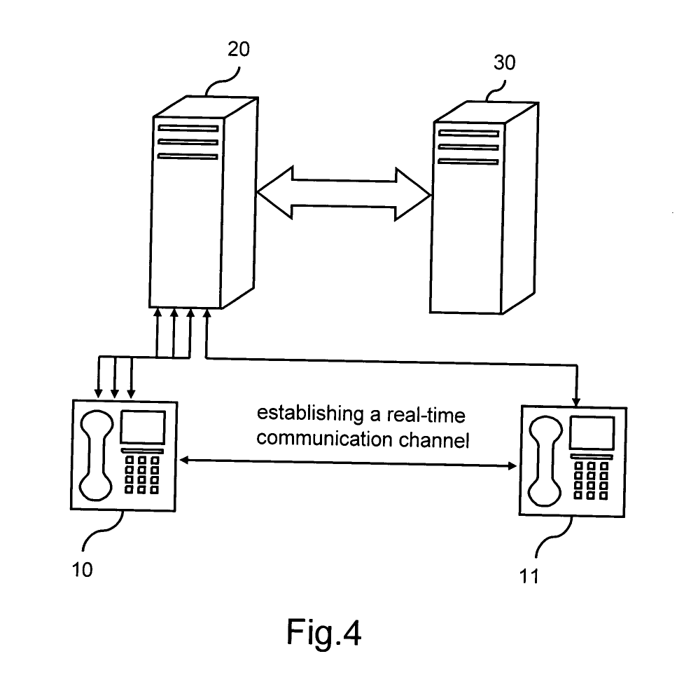

Furthermore, refer to FIG. 4 for a schematic diagram of the VOIP phone call connection system according to an embodiment of the invention. As shown in FIG. 4, the VOIP phone call connection system of the invention includes a first calling party 10, a second calling party 11, a proxy server 20, and an address server 30. In this invention, two parties are used as example for explanation, however, it should not be construed as a limitation. In the implementation of the invention, firstly, the first calling party 10 takes actions applying to the proxy server 20 for a plurality of dialing numbers (for example, the first dialing number, the second number, and the third number) and completing registration through the process of the second embodiment. Next, one of the dialing numbers is used by the first calling party 10 to send out a calling invitation to the proxy server 20, that is utilized to call the second calling party 11. Then, upon receiving the calling invitation, the proxy server 20 inquires and obtains the address information of the second calling party 11 through the address server 30 according to the calling invitation.

Then, the proxy server 20 sends out the calling invitation to the second calling party 11 according to the address information thus obtained. Subsequently, upon receiving the calling invention, the second calling party 11 verifies that it is in a communication allowable state, and returns a confirmation message to the proxy server 20. And finally, upon receiving the confirmation message sent from the second calling party 11, the proxy server 20 relays and transmits such a confirmation message to the first calling party 10. As such, establishing a real-time communication channel for communication between the first calling party 10 and the second calling party 11. In real practice, the dialing numbers registered and obtained can be classified as the internal extension numbers or the external dialing numbers, that can be used in cooperation with software programs and settings of hardware circuits. As such, upon pressing down the inside-extension key on the telephone set, the user may use the extension number (for example, the first dialing number or the second dialing number) to communicate with other telephone set users inside the company; and upon pressing down the outside-line key, the user may use the external dialing number (for example, the third dialing number) to communicate with the outside telephone users. As such, achieving efficient utilization of VOIP and reducing its operation cost.

Through the application of such a multi-dialing-number VOIP phone call connection method, the number of VOIP telephone dialing numbers can be increased through registering a network address with different proxy servers to obtain a plurality of dialing numbers, or through registering several network addresses with the same proxy server to obtain a plurality of dialing numbers. As such, the user may utilize the dialing numbers thus obtained to realize the phone call connection, and switch the phone call connection between the inside extension lines and the outside lines in a hardware or software manner. In addition, the user may further set the utilization conditions (such as the communication allowable time sections or specific dialing numbers allowed) for the various dialing numbers, thus being able to filter out the undesirable incoming calls and achieve raising the convenience of utilizing VOIP.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A multi-dialing-number VOIP phone call connection method, comprising the following steps:
registering by a first calling party with at least two proxy servers utilizing a network address, and obtaining at least two dialing numbers;
issuing by said calling party a calling invitation to said proxy server by making use of one of said dialing numbers;
inquiring the address information of the second calling party by said proxy server according to said calling invitation;
transmitting said calling invitation to said second calling party from said proxy server according to said address information;
returning a confirmation message to said proxy server by said second calling party;
transmitting and relaying such a confirmation message to said first calling party by said proxy server, thus realizing the phone call connection between the two parties; and
establishing a real-time communication channel for transmitting data flow.

2. The multi-dialing-number VOIP phone call connection method, as claimed in claim 1, wherein said proxy server inquires an address server about said address information of said second calling party.

3. A multi-dialing-number VOIP phone call connection method, comprising the following steps:
registering by a first calling party with a proxy server utilizing at least two network addresses, thus obtaining at least two dialing numbers;
issuing by said calling party a calling invitation to said proxy server by making use of one of said dialing numbers;
inquiring the address information of the second calling party by said proxy server according to said calling invitation;
transmitting said calling invitation to said second calling party from said proxy server according to said address information;
returning a confirmation message to said proxy server by said second calling party;
transmitting and relaying such a confirmation message to said first calling party by said proxy server, thus realizing the phone call connection between the two parties; and
establishing a real-time communication channel for transmitting data flow.

4. The multi-dialing-number VOIP phone call connection method as claimed in claim 3, wherein said proxy server inquires an address server about said address information of said second calling party.

5. A multi-dialing-number VOIP phone call connection method, comprising the following steps:
registering by a first calling party with a proxy server utilizing at least two network addresses, and obtaining at least two dialing numbers;
setting all or a part of said the utilization conditions of said dialing numbers, and transmitting them to said proxy servers for storage;
issuing by a second calling party a calling invitation corresponding to one of said dialing numbers to said proxy server;
determining by said proxy server whether said calling invitation sent from said second calling party is compatible with said utilization conditions;
upon determining that said calling invitation is compatible with said utilization conditions, inquiring by said proxy server about the address information of said first calling party according to said calling invitation;
transmitting by said proxy server of said calling invitation to said first calling party according to said address information;
returning a confirmation message to said proxy server by said first calling party;
transmitting and relaying the confirmation message to said second calling party by said proxy server, thus realizing the phone call connection between the two parties; and
establishing a real-time communication channel for transmitting data flow.

6. The multi-dialing-number VOIP phone call connection method as claimed in claim 5, wherein said proxy server inquires an address server about said address information of said first calling party.

7. The multi-dialing-number VOIP phone call connection method as claimed in claim 5, wherein upon determining that said calling invitation is not compatible with said utilization conditions, said proxy server returns a message to said second calling party indicating that the phone connection can not be made.

8. The multi-dialing-number VOIP phone call connection method as claimed in claim 5, wherein said utilization condition is a communication allowable time section. The multi-dialing-number VOIP phone call connection method as claimed in claim 5,
wherein said utilization condition is a specific dialing number allowed.
